(19) United States
(12) Patent Application Publication
(10) Pub. No.: US 2002/0099761 A1
(43) Pub. Date: Jul. 25, 2002

(54) Digital information processing device capable of dynamically interchanging information

(76) Inventor: Shun-Ping Wang, Taipei (TW)

Correspondence Address: BIRCH STEWART KOLASCH & BIRCH, PO BOX 747, FALLS CHURCH, VA, 22040-0747, US

(21) Appl. No.: 09/764,066

(22) Filed: Jan. 19, 2001

(51) Int. Cl. G06F 15/16

(52) U.S. Cl. 709/200; 709/212

(57) ABSTRACT

The present invention provides a digital information interchanging device in which the data interchange is controlled mainly by a portable digital information device, such as a PDA, for getting information from another information processing device, such as a notebook computer. The larger size second device includes a format transformation interface, a communication interface and a signal processing interface. The smaller size first device includes signal transceiving interface and communication interface, which can transmit a command to start up the first device, control the information transmission from the first device and display the information on the second device. As a result, the portable first device can utilize the powerful function of the second device in a dynamic or free moving way.

### BACKGROUND OF THE INVENTION

1. Field of Invention

The present invention relates to a digital information interchanging device in which the information can be interchanged dynamically without the need of connecting the devices through a communication cable and controlled from a statically located device. More particularly, it relates to an information interchanging device in which the information interchange is controlled from a portable digital information device for getting information from a second information processing device.

2. Related Art

Notebook or laptop computers and personal digital assistants (PDA) have been popular as portable electronic information processing devices. The notebook computer and PDAs are somehow different in their functions, so that some people, especially businesspersons, may carry both of them for their needs.

Notebook computers usually have larger dimensions and more functions than PDAs. The notebook computers have more memories, operating in higher speed, and providing functions that PDAs cannot do. But, when using a notebook computer, one has to place the computer on a fixed position, such as on a desk or on laps. In other words, the notebook computer is used in a static state. The steps for using a notebook computer are: first, allocating the computer in a suitable place; second, starting the computer; and third, operating the computer.

On the other hand, a palm-size personal digital assistant is less in function than a notebook computer, but smaller for easy handling. The user can hold and operate a PDA in a hand during standing or even walking. That is, the PDA can be used in a dynamic way.

As described above, the notebook computers and the PDAs can be used in different ways. One has to selectively use one of them according to the situations. It would be great if the functions and data of a notebook computer can be used directly by a PDA. In prior arts, the notebook computer and the PDA are respectively equipped with a communication port, which can be linked by a cable for communication. The notebook computer is installed with a driver for using the PDA as a peripheral of the computer, so that, information edited by the computer can be transferred to the PDA. But the connection is made in a static way. That is, the steps for the connection are: first, placing the notebook computer in a suitable place; second, connecting a communication cable to the notebook computer and the PDA; third, turning on the computer and the PDA; and fourth, running an application program for communication. Though there have been infrared transceivers equipped on some notebook computers and PDAs, the operation manner for communication is still the same that data transfer is controlled by the notebook computer.

### SUMMARY OF THE INVENTION

It is therefore an object of the present invention to provide a digital information interchanging device in which the data interchange is controlled mainly by a portable digital information device, such as a PDA, for getting information from a second information processing device, such as a notebook computer. As a result, the portable digital information device can utilize the powerful function of the second information processing device in a dynamic or free moving way.

To achieve the aforesaid object, the digital information interchanging device according to the present invention includes: a first electronic device having a main system for storing and processing data, a display for showing information, a format transformation interface for converting the data of main system into a cross-platform format, a communication interface for encoding the formatted data into communication signal, and a signal processing interface for transmitting and receiving communication signals; and a second electronic device having a main system for storing and processing data, a display for showing information, a communication interface for encoding commands of the second electronic device, and decoding the communication signal received from the first electronic device into displayable format for the second device, and a signal transceiving interface for transmitting and receiving communication signals. Therefore, the second electronic device can activate the first electronic device to transfer information, and display on the second electronic device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an electrical block diagram of the present invention showing the composition thereof;

FIG. 2 is a flowchart of the present invention showing procedures of starting up the devices;

FIGS. 3A, 3B are flowcharts showing procedures of information interchange; and

FIG. 4 a block diagram of the present invention showing a second embodiment with cable connection between devices.

### DETAILED DESCRIPTION OF THE INVENTION

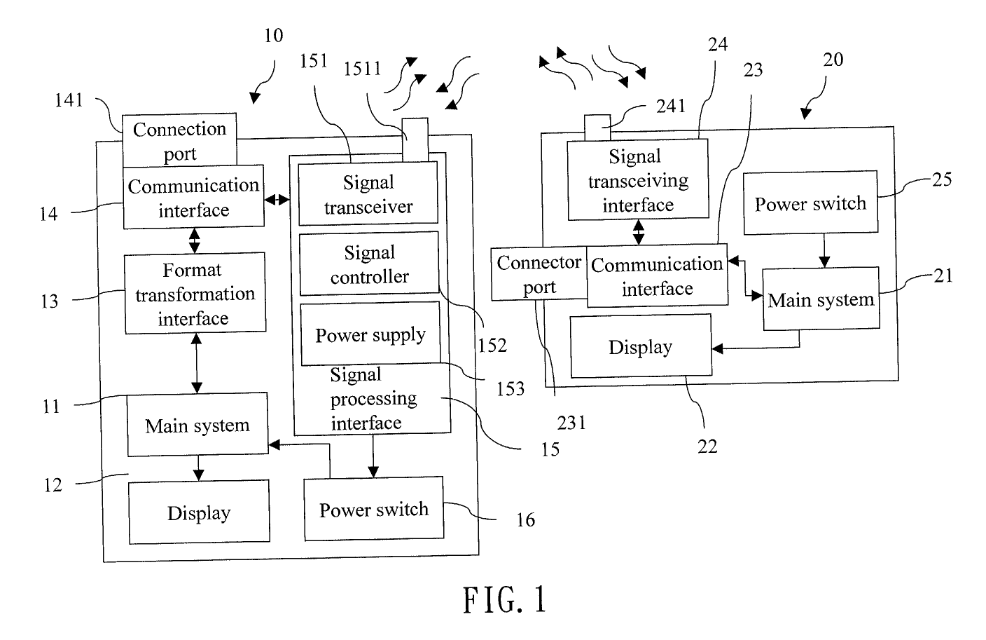

As shown in FIG. 1, a digital information interchanging device according to the present invention includes a first electronic device 10 and a second electronic device 20.

The first electronic device 10 mainly includes a main system 11, a display 12, a format transformation interface 13, a communication interface 14, a signal processing interface 15 and a power switch 16. The main system is composed of a microprocessor, memories and operational circuits for storing and processing data. The display 12 communicates with the main system 11 for showing information executed by the main system 11. The display 12 is controlled by the main system 11. The format transformation interface 13 also communicates with the main system 11 for converting the data of main system 11 into a cross-platform format, which is a commonly readable format for different types of electronic device to read or display. The communication interface 14 communicates with the format transformation interface 13 and the power switch 16. The communication interface 14 will encode the formatted data coming from the format transformation interface 13 into communication signal for wire or wireless communication. The communication interface 14 includes a connection port 141. The signal processing interface 15 communicating with the communication interface 14 includes a signal transceiver 151, a signal controller 152 and a power supply 153. The signal transceiver 151 includes an antenna 1511 for transmitting and receiving communication signals. The signal controller 152 will process the communication signal received by the antenna 1511. The power supply 153 provides electric power for the signal processing interface 15 to maintain in a working state. The power supply 153 is rechargeable that it can be recharged also as the first electronic device 10 is being recharged. The communication signal transferred from the communication interface 14 to the signal processing interface 15 will be transmitted outwards by the signal transceiver 151. The power switch 16 is used to turn on and turn off the first electronic device 10.

The second electronic device 20 mainly includes a main system 21, a display 22, a communication interface 23, a signal transceiving interface 24 and a power switch 25. The main system 21 is composed of a microprocessor, memories sand operational circuits for storing and processing data. The display 22 communicates with the main system 21 for showing information executed by the main system 21. The communication interface 23 communicates with the main system 21 for encoding commands of the second electronic device 20 to be transmitted outwards via wire or wireless method, and decoding the communication signal received from the first electronic device 10 into displayable (cross-platform) format for the display 22. The communication interface 23 further includes a connector port 231. The signal transceiving interface 24 communicating with the communication interface 23 includes an antenna 241 for transmitting and receiving communication signals. The power switch 25 is used to turn on and turn off the second electronic device 20.

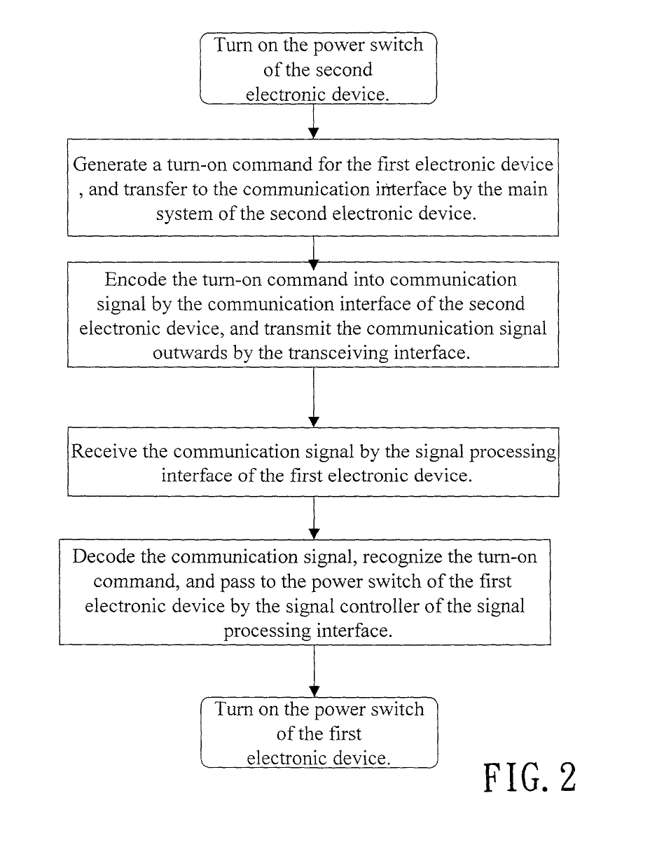

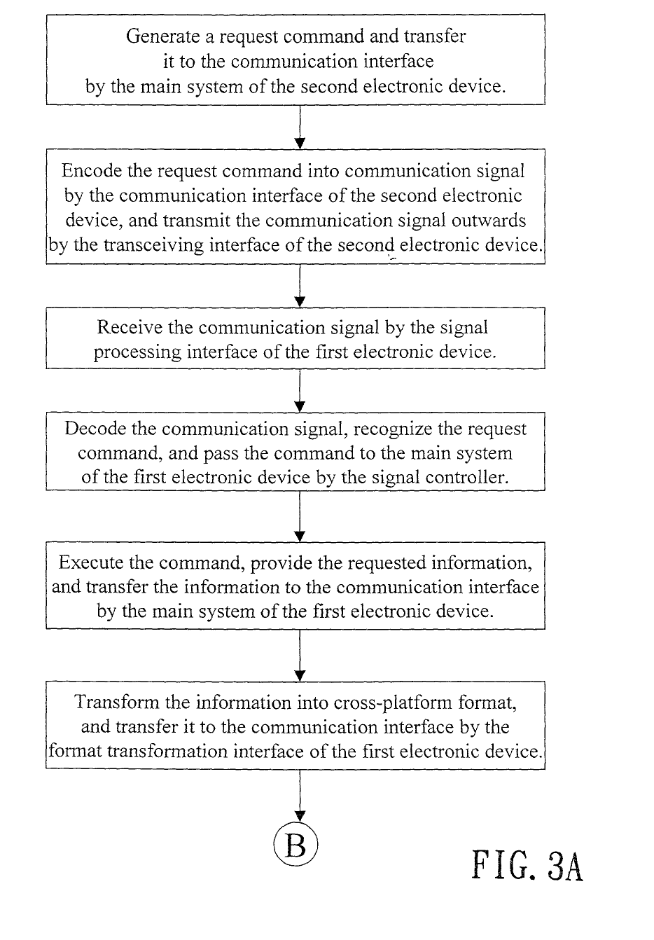

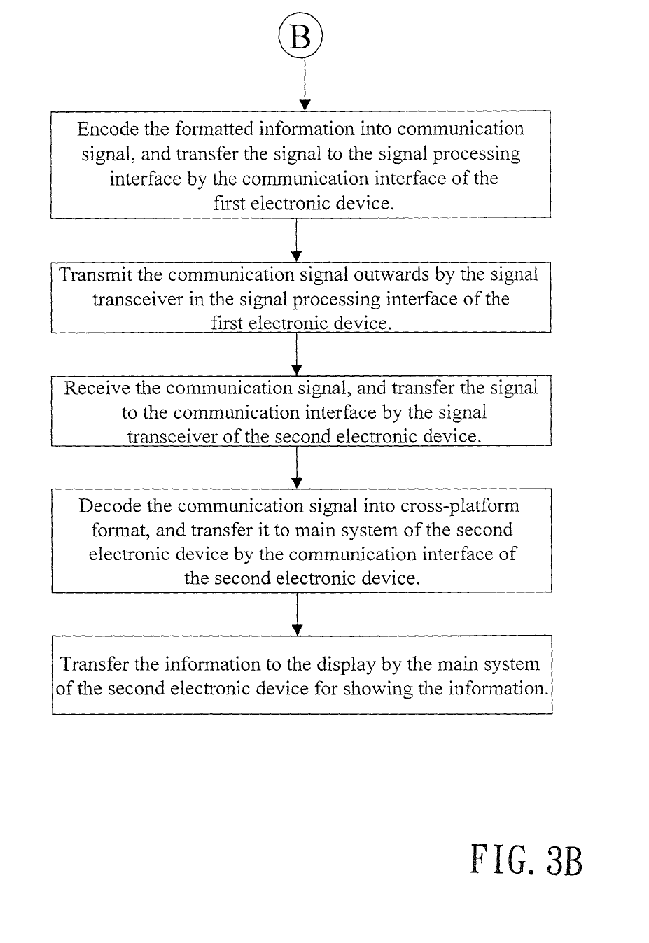

Referring to FIGS. 2, 3A and 3B, the information interchanging procedures between the first and the second electronic devices 10 and 20 are as follows.

A. The second electronic device 20 controls starting up of the first electronic device 10: (FIG. 2)

a) The signal processing interface 15 of the first electronic device 10 is keeping working by power of the power supply 153 for waiting to receive outer signals;

b) The power switch 25 of the second electronic device 20 is turned on by user;

c) The main system 21 of the second electronic device 20 generates a turn-on command for the first electronic device 10, and transfers to the communication interface 24;

d) The communication interface 23 of the second electronic device 20 encodes the turn-on command into communication signal and transfers to the transceiving interface 24;

e) The transceiving interface 24 of the second electronic device 20 transmits the communication signal outwards;

f) The signal transceiver 151 in the signal processing interface 15 of the first electronic device 10 receives the communication signal transmitted from the second electronic device 20, and transfers to the signal controller 152;

g) The signal controller 152 decodes the communication signal, recognizes the turn-on command, and passes to the power switch 16;

h) The power switch 16 turns on the main system 11, but does not turn on the display 12 in order to save power.

B. Information interchange between the first electronic device 10 and the second electronic device 20: (FIGS. 3A, 3B)

a) The main system 21 of the second electronic device 20 generates a request command and transfers to the communication interface 23;

b) The communication interface 23 of the second electronic device 20 encodes the request command into communication signal and transfers to the transceiving interface 24;

c) The transceiving interface 24 of the second electronic device 20 transmits the communication signal outwards;

d) The signal transceiver 151 in the signal processing interface 15 of the first electronic device 10 receives the communication signal transmitted from the second electronic device 20, and transfers to the signal controller 152;

e) The signal controller 152 decodes the communication signal, recognizes the request command, and passes to the main system 11;

f) The main system 11 executes the command, provides the requested information, and transfers to the format transformation interface 13;

g) The format transformation interface 13 of the first electronic device 10 transforms the information into cross-platform format, and transfers to the communication interface 14;

h) The communication interface 14 of the first electronic device 10 encodes the formatted information into communication signal, and transfers to the signal processing interface 15;

i) The signal transceiver 151 in the signal processing interface 15 of the first electronic device 10 transmit the communication signal outwards;

j) The signal transceiver 24 of the second electronic device 20 receives the communication signal, and transfers to the communication interface 23;

k) The communication interface 23 of the second electronic device 20 decodes the communication signal into cross-platform format, and transfers to main system 21;

l) The main system 21 transfers the information to the display 22 for showing the information.

By the aforesaid procedures, the second electronic device 20 can remotely activate the main system 11 of the first electronic device 10, but not activate the display 12 of the first electronic device 10. The second electronic device 20 controls the first electronic device 10 to transfer required information, and displays the information on the display 22 of the second electronic device 20. Therefore, the user can use the second electronic device 20, such as a PDA dynamically, i.e., in a freely movable state, to attain information of the first electronic device 10, utilize the more powerful functions of the first electronic device 10, and achieve information interchange.

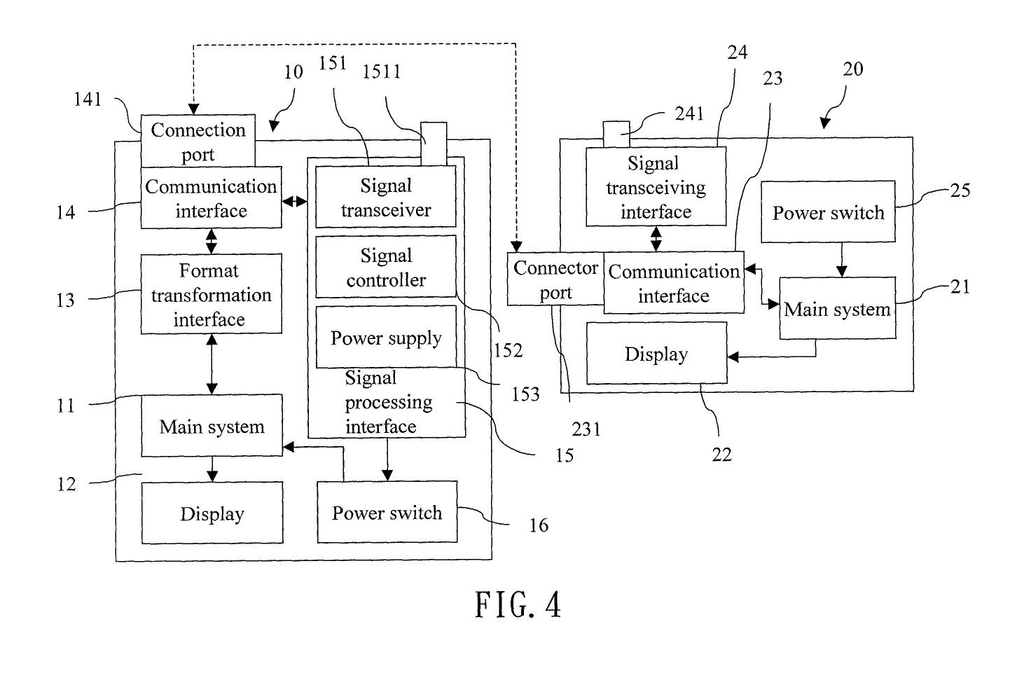

As shown in FIG. 4, a second embodiment of the present invention, as the distance between the first and the second electronic devices 10, 20 is suitable, a communication cable 30 is used to connect the connector port 141 of the first electronic device 10 and the connector port 231 of the second electronic device 20. So that, the information interchange can be achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital information processing device capable of dynamically interchanging information, comprising:
a first electronic device, composed of:
a main system for storing, processing data and executing commands,
a display, communicating with said main system, for showing information,
a format transformation interface, communicating with said main system, for converting data of said main system into a cross-platform format,
a communication interface, communicating with said format transformation interface, for encoding said formatted data into communication signal,
a signal processing interface, communicating with said communication interface, for transmitting outwards and receiving communication signals, and
a power switch, connecting with said main system and said signal processing interface, for turning on said main system, and receiving communication signals coming from said signal processing interface to turn on said main system; and
a second electronic device, composed of:
a main system for storing, processing data and executing commands,
a communication interface, communicating with said main system, for encoding commands generated by said second main system into communication signal, and decoding communication signal received from said first electronic device into cross-platform format,
a signal transceiving interface, communicating with said communication interface, for transmitting outwards said communication signal coming from said communication interface, and receiving communication signal transmitted by said first electronic device,
a display, communicating with said main system, for showing information of said main system, and showing said cross-platform formatted information of said first electronic device transferred by said communication interface, and
a power switch, connected to said main system, for turning on said main system.

2. A digital information processing device according to claim 1 in which the first electronic device is a notebook computer.

3. A digital information processing device according to claim 1 in which the second electronic device is a personal digital assistant.

4. A digital information processing device according to claim 1 in which said display of the first electronic device is not activated during information interchange of the first and second electronic devices, so as to save power of said first electronic device.

5. A digital information processing device according to claim 1 in which said first and said second electronic devices are respectively equipped with a connector port, so as to be connected through a communication cable for interchanging information.

6. A digital information processing device according to claim 1 in which said signal processing interface of the first electronic device further includes:
a signal transceiver, for transmitting communication signal of said first electronic device and receiving communication signal transmitted by said second electronic device;
a signal controller, for processing and recognizing said communication signal so as to turn on the power switch of said first electronic device and start up the main system thereof; and
a power supply, for providing electric power to said signal processing interface and maintaining the same in a working state.

7. A digital information processing device according to claim 6 in which said signal transceiver includes an antenna.

8. A digital information-processing device according to claim 1 in which said signal transceiving interface of the second electronic device includes an antenna.
